(19) United States
(12) Patent Application Publication
(10) Pub. No.: US 2015/0325134 A1
(43) Pub. Date: Nov. 12, 2015

(54) SYSTEM AND METHOD FOR ELECTRONIC AND INTERACTIVE LEGAL EDUCATION

(71) Applicant: D. Adam Candeub, Okemos, MI (US)

(72) Inventor: D. Adam Candeub, Okemos, MI (US)

(21) Appl. No.: 14/274,901

(22) Filed: May 12, 2014

(51) Int. Cl. G09B 9/00; G09B 19/00

(52) U.S. Cl. CPC G09B 9/00; G09B 19/00

(57) ABSTRACT

The invention is a system and method for electronic and interactive legal education. In one embodiment, a computer system presents a student with interactive virtualized scenarios. These scenarios present a variety of available actions to the student. Each available action corresponds to one or more legal principles to be taught in a particular scenario. In another embodiment, the scenarios are presented to the student as a role-playing game. The game could be won depending on the legal outcomes of the actions taken by the student. The scenarios presented by the game could be reenactments or simulations of legal cases or controversies. The game could allow the student to play the role as a character involved in the cases or controversies. The game could allow the student to choose between a plurality of non-attorney parties as their character.

### FIELD OF THE INVENTION

This invention relates generally to the field of digital learning systems and methods. More particularly, the invention relates to a system and method for electronic and interactive legal education.

### BACKGROUND OF THE INVENTION

Lawyers are a notoriously old fashioned group of people. Legal education as it exists today has remained largely unchanged since the late 19th century. The study of law is generally based on the study of cases which provide rules of law that govern particular legal issues. Professors lecture quite little, instead, asking questions about the cases to specific students. It is the dialogue that is believed to foster discipline and understanding in the law students. This method of education, known as the Socratic method, has endured for so long due to its relatively uncontested success at teaching law students to think like a lawyer. This method represents the bulk of legal education in the United States.

The typical law school exam is an essay exam where the student is presented with a fact pattern containing various legal issues. The student is expected to identify as many issues as possible, identify the correct rule governing each issue, and apply the rules to the corresponding issues to reach the right legal conclusions. When a law exam is a multiple-choice based exam, a fact pattern is similarly presented and students are asked to choose the right rule or outcome for the fact pattern. While some professors give midterm exams and provide feedback, there is generally only one final exam where only the students who decide to meet with their professors will actually learn from their exams.

Non-traditional, but rather prevalent, forms of legal education have arisen in the form of legal clinics or practica where students have real or simulated clients and students are expected to act as their attorneys. In this format, students are supervised and given feedback by their professors on their submissions, enabling a more active form of learning. Other classes are lecture-based seminars where students are expected to write a paper on a topic based on the same subject matter as the seminar. These forms of legal education are similarly heralded as effective due to the student engagement with the subject matter.

While electronic forms of legal education do exist, they are largely unengaging. Students view recorded lectures and then do a variety of practice problems related to the lectured material. Some are more exciting than others, generally aimed at high school students, with vibrant graphics, entertaining characters, and engaging clients, but ultimately boil down to a fact pattern followed by sequential multiple choice questions. As online and home-based education rises in prevalence and popularity, the future success of law schools in the modern digital context requires effective electronic education. The generations of law students to come will have grown up with entertainment like Grand Theft Auto and will have high expectations of any electronic educational content. Accordingly, what is needed is electronic legal education that is engaging and interactive.

### SUMMARY

The present invention provides a system and method for electronic and interactive legal education. In one embodiment, the system or method includes providing legal education though a role-playing computer game. The computer game presents interactive virtualized scenarios wherein the scenarios present a set of available actions with consequences to the player. At least one of the actions in the virtualized scenarios correspond to one or more legal principles to be taught in the particular virtualized scenario. In another embodiment, the interactive virtualized scenarios are reenactments or simulations of events underlying a case or controversy in which the player assumes the role of an involved person.

In addition to the obvious benefits of engaging educational material, one advantage of these embodiments to other forms of electronic legal education is that they engage students directly with a legal scenario, often under pressure to make decisions in a limited time, rather than post-event analysis as a detached lawyer. Many times, understanding the motivations of the involved parties is necessary to making policy arguments as to why a law may be good or bad, a common part of legal practice. One other benefit of the invention is that it allows the outcomes of the scenarios to be changed based on the evolution of the law through updating of the role-playing game or other embodiment. The updating could be accomplished through typical means for software such as automatic updates, manual downloads, expanded software versions, and other forms of updating software.

One additional advantage of these embodiments to other forms of electronic legal education is that they are entertaining and emotionally engaging. While legal education is considered a painfully boring experience by many, televesion series and movies about lawyers and their cases are often entertaining due to their ability to emotionally engage the audience. Keeping students motivated through entertaining educational content will help fend off the variety of emotional and psychological problems faced by often overworked law students, as well as more effective legal education.

### BRIEF DESCRIPTION OF THE DRAWINGS

Advantages of the present invention will be readily appreciated as the same becomes better understood by reference to the following detailed description when considered in connection with the accompanying drawings wherein:

FIG. 1 is a flowchart describing a system or method of interactive and electronic legal education; and

FIG. 2 is a flowchart describing a system or method of interactive and electronic legal education as a game.

### DETAILED DESCRIPTION

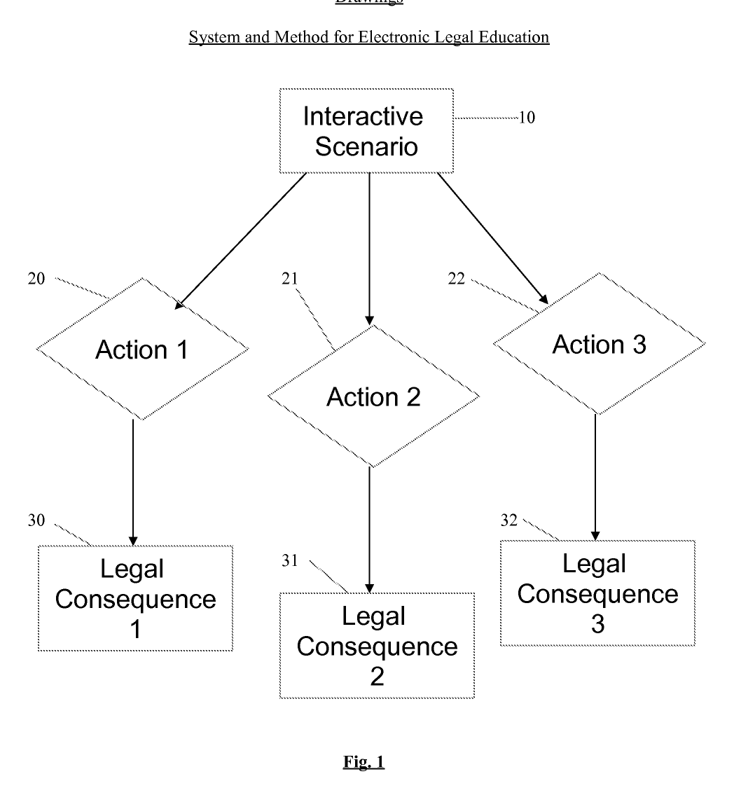

Referring to FIG. 1, a system or method of interactive and electronic legal education is disclosed. In this embodiment, students are presented with interactive scenario 10. An interactive scenario is a representation of a set of facts and circumstances, real or hypothetical, with which the student can interact though various actions. By way of illustration, FIG. 1 shows the availability of three actions: 20, 21, and 22. There can be any number of actions available to the student with which to interact with the scenario. In this embodiment, every action corresponds to a legal consequence. The omission of an action may also correspond to a particular legal consequence. By way of illustration, FIG. 1 shows three legal consequences, 30, 31, and 32, respectively associated with actions 20, 21, and 22. Not every action must have a legal consequence, and may simply serve to progress a story or narrative associated with interactive scenario 10.

### As a Game

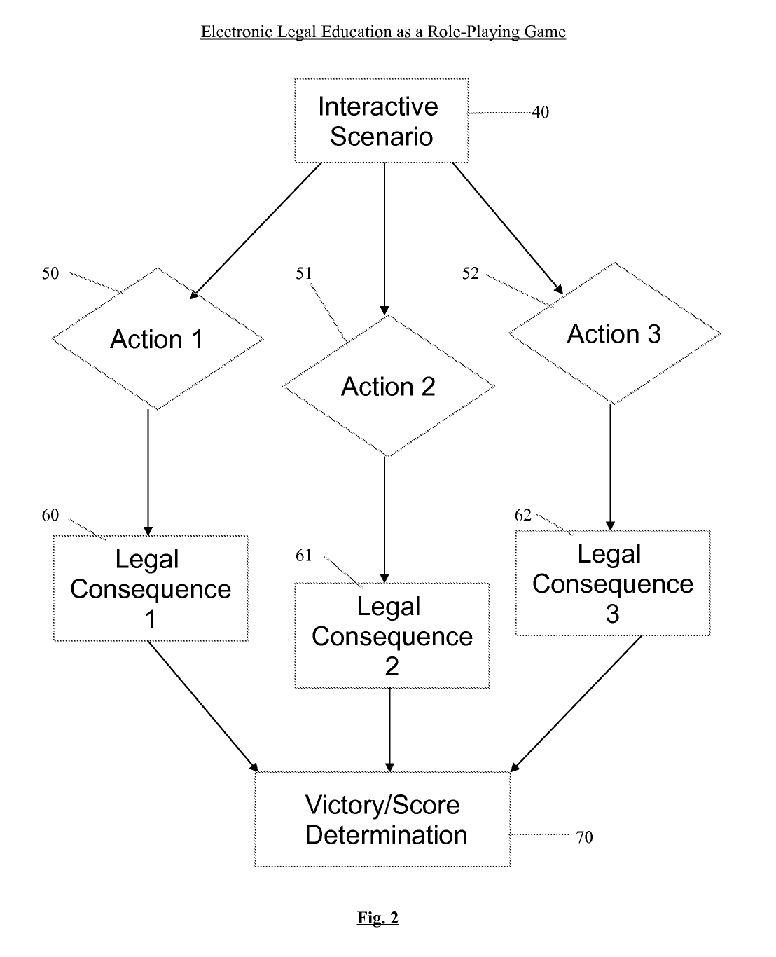

Referring to FIG. 2, a system or method of interactive and electronic legal educations as a game is disclosed. Similar to the embodiment of FIG. 1, in this embodiment students are presented with interactive scenario 40. By way of illustration, FIG. 2 similarly shows the availability of three actions: 50, 51, and 52. There can be any number of actions available to the student with which to interact with the scenario. In this embodiment, every action corresponds to a legal consequence. The omission of an action may also correspond to a particular legal consequence. By way of illustration, FIG. 2 similarly shows three legal consequences, 60, 61, and 62, respectively associated with actions 50, 51, and 52. Not every action must have a legal consequence, and may simply serve to progress a story or narrative associated with interactive scenario 40.

In this embodiment, the system or method is a game. By way of example, the game can be a role-playing game. A role-playing game is a game in which the player assumes the role of a character, making decisions in their stead, with the purpose of achieving the results desired by the character. By way of example, the student could assume the role of a law enforcement officer, making decisions in their stead as to the manner of investigating a crime, with the purpose of achieving the result of apprehending and convicting the correct perpetrator of the crime. By way of a second example, the student could assume the role of a suspected criminal under police investigation, making decisions in their stead as to the manner of interacting with the police, with the purpose of achieving the result of avoiding incarceration.

Beyond the embodiment disclosed in FIG. 1, FIG. 2 further discloses victory/score determination 70. The actions taken by the students can determine whether the student has won or lost the interactive scenario in the game. Additionally or alternatively, the actions taken by the students can determine a score for their performance in the interactive scenario. As a system or method for legal education, victory and score will be related to the legal consequences of the actions taken by the student in the interactive scenario. For example, if the actions taken by the student are illegal, or lead to unfavorable legal outcomes, the student can lose the game. Furthermore, in a game where a student is scored, the student who takes actions that are illegal or have unfavorable legal outcomes can receive a lower score than if they had taken actions with more favorable legal outcomes. In either case, the student can be provided with textual, audio, or visual feedback, or any combination of the above, based on the actions they took in the course of playing the game to further the learning experience.

### Alternative Embodiments

In any of the embodiments the interactive scenarios can be reenactments or simulations of legal cases or controversies. In other words, the interactive scenarios can be based on the facts and circumstances of real legal cases or controversies. These reenactment interactive scenarios can help students practice their understanding of a case. Alternatively, the interactive scenarios can be based on hypothetical facts and circumstances of a fictional legal case or controversy. These simulated interactive scenarios can help students develop their ability to analogize from prior cases. In either case, these scenarios may be presented as textual, visual, or audio representations, or any combinations of the above.

In any of the role-playing game embodiments the role the student takes in the game can be as any character involved in a case or controversy. In addition to the examples provided in paragraph [0014] a student can play the part of an expert witness, a lay witness, a crime victim, a plaintiff, a criminal defendant, an attorney, a judge, law enforcement officer, a tortfeasor, or other individuals whose actions have conceivable legal consequences in a legal case or controversy.

In any of the role-playing game embodiments the student can choose between a plurality of non-attorney or attorney parties as their character. While the game may be limited to only one character, like the attorney involved, the student can be given a choice of various non-attorney parties involved in the interactive scenario. In fact, the game does not need to include attorney characters at all. The game may also include a multiplayer configuration, or leaderboards, that allows for several students to assume the various available roles and operate collaboratively or competitively to create a further engaging learning experience.

A person of ordinary skill in the art will recognize that any of these embodiments can be implemented through software or hardware, and potentially as a mixture of both, as in a computer or as instructions stored in a non-transitory computer-readable or other machine-readable medium. User input can be by any means, including keyboard, mouse, gamepad, touch command, voice commands, or other means of providing input to the computer device. A person of ordinary skill in the art will also recognize that a computer device is any device with a processor and some form of memory, including personal computers, mobile devices, tablets, game consoles, and any other device with the ability to execute computational instructions.

Obviously, many modifications and variations of the present invention are possible in light of the above description. While this description is directed to particular embodiments, it is understood that those skilled in the art may conceive of modifications and/or variations to the specific embodiments shown and described herein. Any such modifications or variations, which fall within the purview of this description, are intended to be included herein as well. It is understood that the description herein is intended to be illustrative only and is not intended to be limited.

What is claimed is:

1. A computer-implemented method for electronic legal education comprising:
presenting a student with interactive virtualized scenarios,
wherein the scenarios present a variety of available actions to the student,
wherein at least some subset of the available actions correspond to one or more legal principles to be taught in a particular scenario.

2. The computer-implemented method according to claim 1, wherein the interactive virtualized scenarios are presented to the player as a role-playing game.

3. The computer-implemented method according to claim 2, wherein the role-playing game is won depending on the legal outcomes of the actions taken by the student.

4. The computer-implemented method according to claim 1, wherein the interactive virtualized scenarios are reenactments or simulations of legal cases or controversies.

5. The computer-implemented method according to claim 2, wherein the role the student takes in the role-playing game is as a character involved in a case or controversy.

6. The computer-implemented method according to claim 5, wherein the student can choose between a plurality of non-attorney parties as their character.

7. A system for electronic legal education comprising:
presenting a student with interactive virtualized scenarios on a computer,
wherein the scenarios present a variety of available actions to the student,
wherein at least some subset of the available actions correspond to one or more legal principles to be taught in a particular scenario.

8. The system according to claim 7, wherein the interactive virtualized scenarios are presented to the player as a role-playing game.

9. The system according to claim 8, wherein the role-playing game is won depending on the legal outcomes of the actions taken by the student.

10. The system according to claim 7, wherein the interactive virtualized scenarios are reenactments or simulations of legal cases or controversies.

11. The system according to claim 8, wherein the role the student takes in the role-playing game is as a character involved in a case or controversy.

12. The system according to claim 11, wherein the student can choose between a plurality of non-attorney parties as their character.

13. A non-transitory machine-readable medium containing instructions for a method of electronic legal education, the method comprising:
presenting a student with interactive virtualized scenarios,
wherein the scenarios present a variety of available actions to the student,
wherein at least some subset of the available actions correspond to one or more legal principles to be taught in a particular scenario.

14. The non-transitory machine-readable medium according to claim 13, wherein the interactive virtualized scenarios are presented to the player as a role-playing game.

15. The non-transitory machine-readable medium according to claim 14, wherein the role-playing game is won depending on the legal outcomes of the actions taken by the student.

16. The non-transitory machine-readable medium according to claim 13, wherein the interactive virtualized scenarios are reenactments or simulations of legal cases or controversies.

17. The non-transitory machine-readable medium according to claim 14, wherein the role the student takes in the role-playing game is as a character involved in a case or controversy.

18. The non-transitory machine-readable medium according to claim 17, wherein the student can choose between a plurality of non-attorney parties as their character.
